(19) United States
(12) Patent Application Publication
(10) Pub. No.: US 2017/0211903 A1
(43) Pub. Date: Jul. 27, 2017

(54) FANG MOUNT

(71) Applicant: Contract Fabrication and Design LLC, Princeton, TX (US)

(72) Inventors: Jesse DAVISON, McKinney, TX (US); David DIERKS, McKinney, TX (US); Jarrett O'HARA, Plano, TX (US); Russell MENSCH, Allen, TX (US); Chris FELLEGY, Sadler, TX (US); Chris KNIFFIN, Arlington, TX (US)

(21) Appl. No.: 15/008,208

(22) Filed: Jan. 27, 2016

(51) Int. Cl. F41A 23/02; B64D 7/08; F41A 11/02; B64D 7/02

(52) U.S. Cl. CPC F41A 23/02; B64D 7/02; B64D 7/08; F41A 11/02

(57) ABSTRACT

An IDAS compatible weapons mounting platform for a helicopter, such as the UH-1, that allows two weapon stores, including Hellfire, to mount to each side of the aircraft. The platform is compatible with a broad array of weapons, such as the Hellfire and other smart weapons, and increases the total weapon payload to 1,000 lbs per aircraft side, while having positive safety margins throughout the flight profile.

### FIELD OF THE DISCLOSURE

This disclosure is generally directed to armament systems, and more particularly to a weapons mounting platform for helicopters outfitted with an Improved Defense Armament System (IDAS) that is mounted at a 45 degree angle with respect to the helicopter cabin.

### BACKGROUND

Recent upgrades to the UH-1 helicopter increased the aircraft's payload capacity, however, the IDAS conventionally outfitted on the UH-1 is not designed to leverage this new capability due to the design of the single 45 degree mounted bomb release unit. Thus, only one weapon store is able to be mounted each side of the aircraft.

### SUMMARY

A IDAS compatible weapons mounting platform for a helicopter, such as the UH-1, that allows two weapons stores, including Hellfire, to mount to each side of the aircraft. The platform is compatible with a broad array of weapons, such as the Hellfire and other smart weapons, and increases the total weapon payload to 1,000 lbs per aircraft side, while having positive safety margins throughout the flight profile. The weapons mounting platform is adapted to secure to the IDAS because it is already equipped on multiple helicopters and it takes advantage of existing equipment without redesign, thus saving cost.

In one exemplary embodiment, a weapons mounting platform configured to secure to an IDAS mounted to a helicopter, the IDAS having a pair of mounting arms, a support bar secured to and extending between the pair of mounting arms, and a pintle post. The platform includes an inboard store station configured to selectively and securably mount to the IDAS, the inboard store station having a first elongated member including a first store mount defined by two sets of mounting lugs, and configured to extend horizontally from the helicopter when secured to the IDAS. The platform also includes an adapter configured to selectively secure the inboard store station to the IDAS, and an outboard store station configured to selectively and securably mount to the inboard store station, the outboard store station having a second elongated member including a second store mount, and configured to extend horizontally from the helicopter when secured to the inboard store station. The adapter is configured to secure to the support bar of the IDAS.

The first elongated member is coplanar with the second elongated member. The platform includes a fastener configured to selectively secure an inboard end of the outboard store station to an outboard end of the inboard store station, wherein the inboard end of the outboard store station and the outboard end of the inboard store station each comprise openings configured to receive the fastener with zero tolerance.

The adapter has a recess configured to receive an inboard end of the inboard store station. An outboard end of the inboard store station has a recess configured to receive an inboard end of the outboard store station. The outboard store station has a pair of the second store mounts defined by three sets of mounting lugs.

### BRIEF DESCRIPTION OF THE FIGURES

FIG. 1 illustrates a perspective view of a weapons mounting platform;

FIG. 2 illustrates a conventional IDAS including a pair of outwardly curved support arms, a support bar secured to and extending between the upper ends of support arms, and a pintle post;

FIG. 3 illustrates a front view of the weapons mounting platform secured to left side of the helicopter via the IDAS;

FIG. 4 illustrates a partial exploded view of the IDAS, including one adapter having an opening receiving a respective end of the support bar;

FIG. 5 illustrates hardware, such as bolts, extending through the pair of openings in the adapter and through the openings in the support bar, to secure the respective adapter to the respective end of support arm;

FIG. 6 illustrates openings configured to accept hardware, which hardware extends through the openings and through corresponding openings at an inboard arm of the inboard store station to secure the inboard store station to the adapter;

FIG. 7 illustrates a partial exploded view of the outboard store station and the inboard store station;

FIG. 8 and FIG. 9 illustrate a complete station that extends generally horizontal from the side of the helicopter cabin; and

FIG. 10 illustrates a front view of the inboard store station and the outboard store station including the weapon stores, including three sets of evenly spaced lugs integrated into the outboard store station for gun mounts and North Atlantic Treaty Organization (NATO) 14-inch bomb racks for jettisonable payloads.

### DETAILED DESCRIPTION

The present disclosure provides an IDAS compatible weapons mounting platform for helicopters that replaces the legacy bomb release unit mount with the components, and reuses the support arms and pintle post. The weapons mounting platform comprises an adapter configured to mount to the support arm, an inboard store station and a selectively attachable/detachable outboard store station. The inboard store station remains installed on the aircraft at all times.

In one illustrative embodiment, the weapons mounting platform is designed to adapt to the IDAS mount currently on the Bell UH-1 helicopter. The platform provides the ability to carry four weapon stores using NATO 14-inch bomb racks. Stores are located so that minimum military spec clearances are adhered to and moment arms are diminished. The outboard store station can be completely removed from the inboard store station by removing quick-release expansion pins. Bomb rack adapters are designed to mount to two sets of mounting lugs. This allows any number of alternate gun mounts that are compatible with the mounting lugs to replace a store that requires a 14-inch bomb rack.

The weapons mounting platform structure does not reduce depression limits of the pintle post weapon when the outboard store station is removed (inboard store station only). Depression limits remain the same as limits for legacy bomb rack. Lots of consideration was taken into location of the two outer stores as the moment is greatly increased as the stores move outboard.

One challenging part of the design was making it strong enough to support the very heavy stores and also ensuring that these stores pass military spec clearances. The lugs on the helicopter are likely the weak link in the design and are a limiting factor as to how much weight the system can support. The design of this weapons mounting platform achieves the military spec clearances.

The outboard store station is attached to the inboard store station via precision-machined lugs and quick-release expansion pins. These pins ensure a zero-clearance fit between the components, thus guaranteeing boresight retention and pinpoint accuracy of the attached weapon.

The weapons mounting platform is modular, allowing for maximum firepower when it is needed, and instant weight savings when it is not. The platform is very low maintenance and damage tolerant.

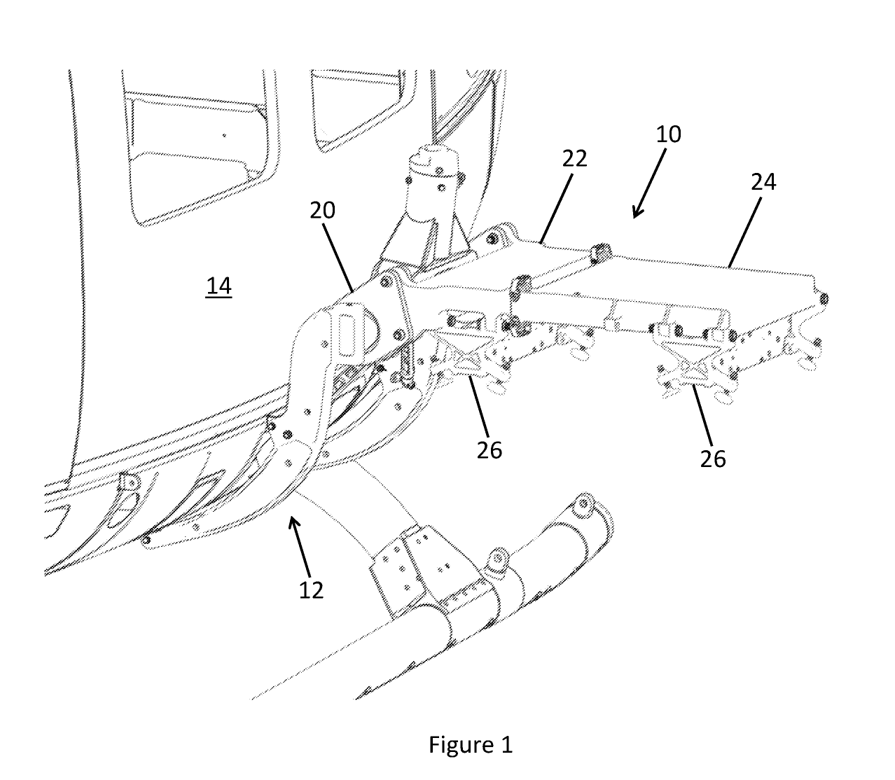

Referring to FIG. 1, there is shown a perspective view of a weapons mounting platform 10 according to one embodiment of this disclosure secured to an IDAS 12, which IDAS 12 is secured to a helicopter 14 as is conventional. In one embodiment, the helicopter 14 may be a Bell UH-1.

The weapons mounting platform 10 comprises three main components, an adapter 20 configured to be secured to the IDAS 12, an inboard store station 22, and an outboard store station 24. The outboard store station 24 is configured to be selectively and securely mounted to the inboard store station 22 using hardware, and also to be easily unmounted from the inboard store station 22 when chosen. Each of the inboard store station 22 and the outboard store station 24 are outfitted with a pair of bomb rack adapters 26 that are configured to securely receive numerous types of weapons using a NATO 14-inch bomb rack.

The weapons mounting platform 10 is compatible with all of the weapons and attachments listed below. All weapons and combinations have proper military spec jettison clearance.
M2/M3/M3D/M3M/M3P/GAU-18/GAU-21 .50 cal machine gun
GAU-19.50 cal Gatling gun
M134 7.62 mm Gatling gun
MK19 40 mm grenade launcher
M260/LAU-68 7-shot rocket pod
M261/LAU-61 19-shot rocket pod
TALON 2.75-inch laser guided rocket
DAGR 2.75-inch guided missile
M310 missile launcher, 2-rail, AGM-114 Hellfire
Viper Strike guided glide bomb
Griffin laser-guided bomb
Stinger AIM-92
NC-621 20 mm Cannon
M134 7.62 mm Gatling gun mount
M2/M3 .50 cal machine gun mount
Target spotting lasers and mounts
External auxiliary fuel cell

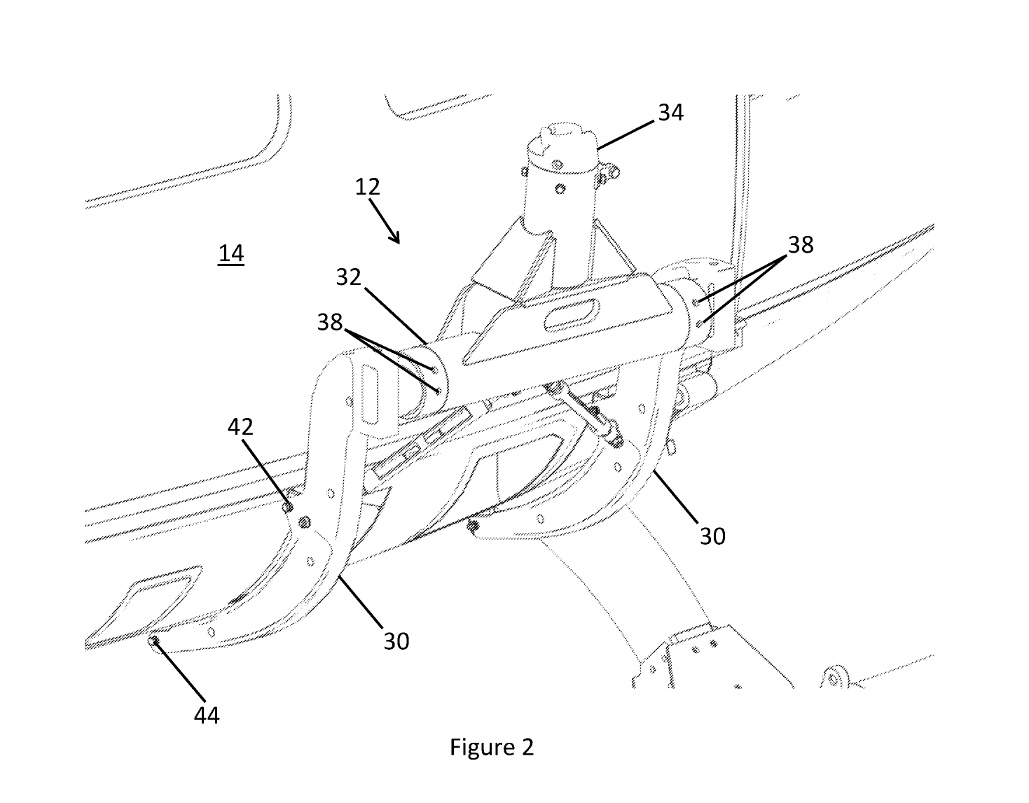

Referring to FIG. 2, there is shown a conventional IDAS 12 including a pair of outwardly curved support arms 30, a support bar 32 secured to and extending between the upper ends of support arms 30, and a pintle post 34. The support bar 32 is seen to include a pair of openings 38 at each end of the support bar 32, and which are configured to face laterally outward at about a 10 degree angle above a horizontal plane. Each of the support arms 30 are configured to be secured to the airframe of the helicopter 14 using mounting hardware at a midsection of the support arms 30 shown at 42, and at a lower section of the support arms 30 as shown at 44.

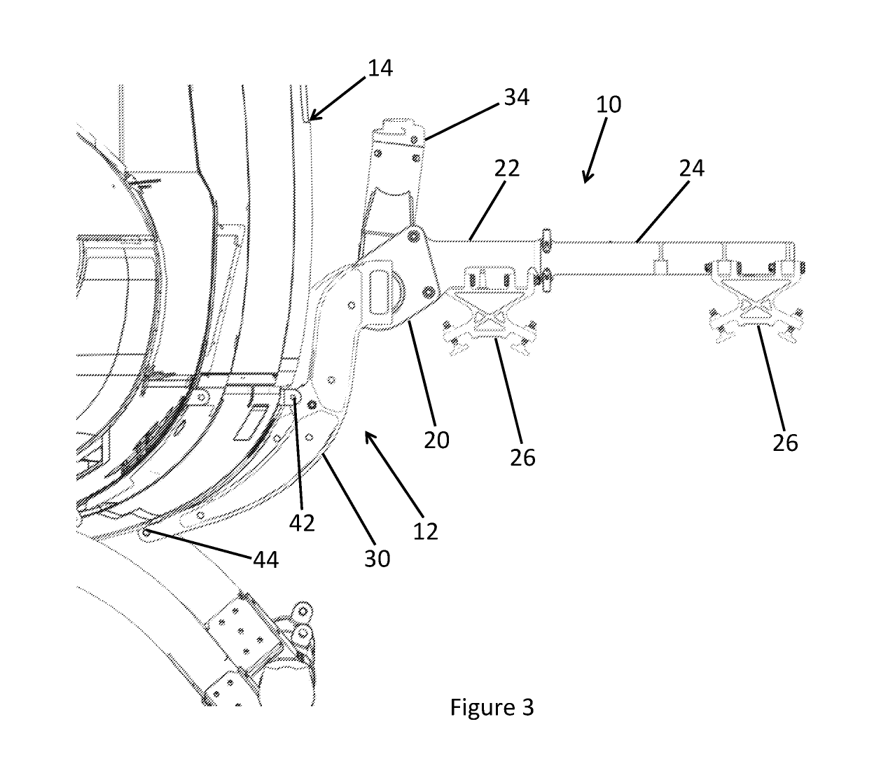

FIG. 3 illustrates a front view of the weapons mounting platform 10 secured to the left side of the helicopter 14 via the IDAS 12. The platform 10 is also configured to mount to the right side of the helicopter 14 (not shown) such that the helicopter 14 can be outfitted with a total of four weapon stores. The platform 10 achieves the military spec clearances of MIL-STD-1289.

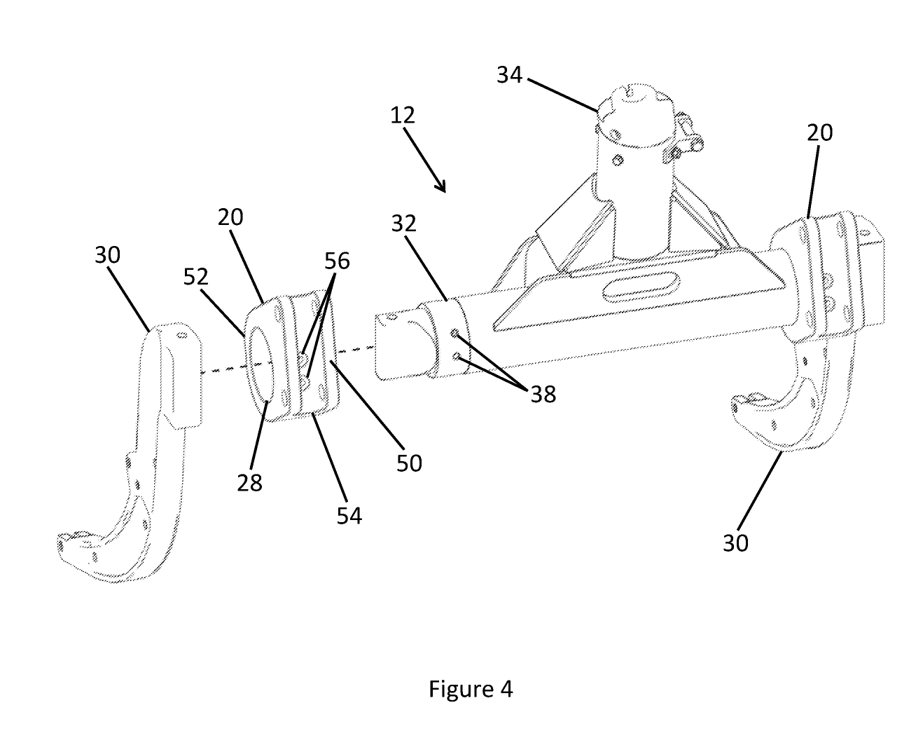

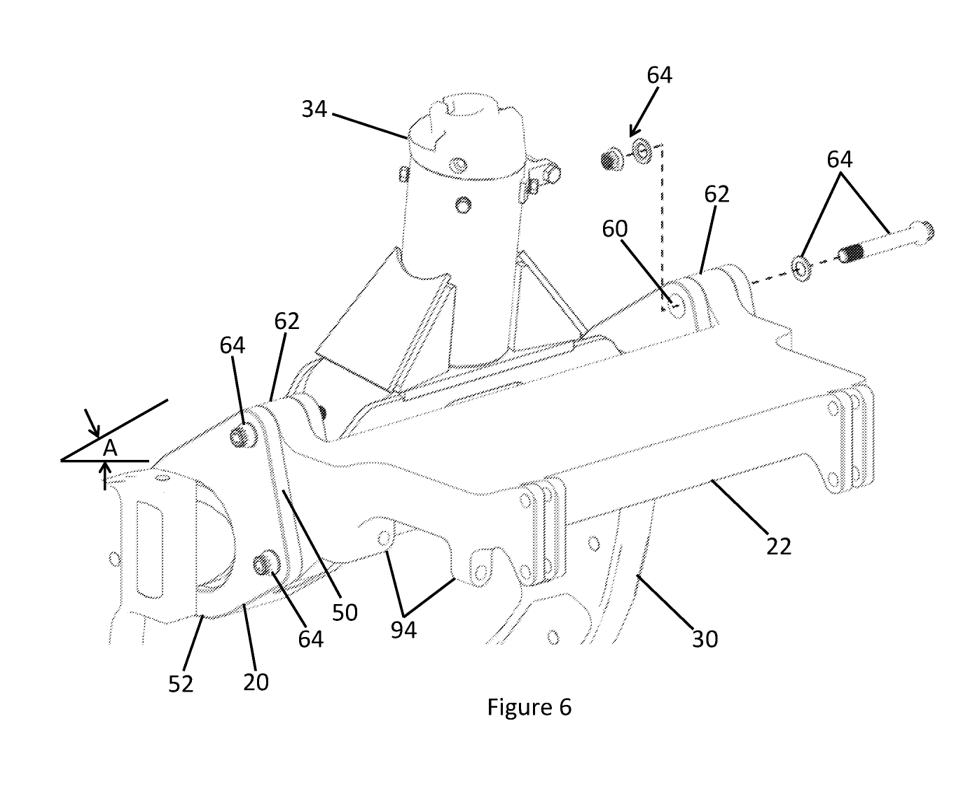

FIG. 4 illustrates a partial exploded view of the IDAS 12, including one adapter 20 having an opening 28 receiving a respective end of the support bar 32. Each adapter 20 is shaped generally like the letter D, having a straight side 50 and an outwardly curved portion 52 extending from the top of the straight side 50 to the bottom of the straight side 50. Each adapter 20 extends at an upward angle A between the support bar and an inboard end of the inboard store station to allow the hardware 58 to enter normal to the surface about the openings 56 and openings 38 to keep the store stations separated from the ground to comply with military spec clearances with the ground (FIG. 6). The straight side 50 has an elongated, inwardly curved, outer surface 54, a pair of openings 56 extending through opening 28, and through the outward curved portion 52. The respective pairs of openings 56 are spaced from one another and line up with the pair of openings 38 each side of the support bar 32 as shown in FIG. 2.

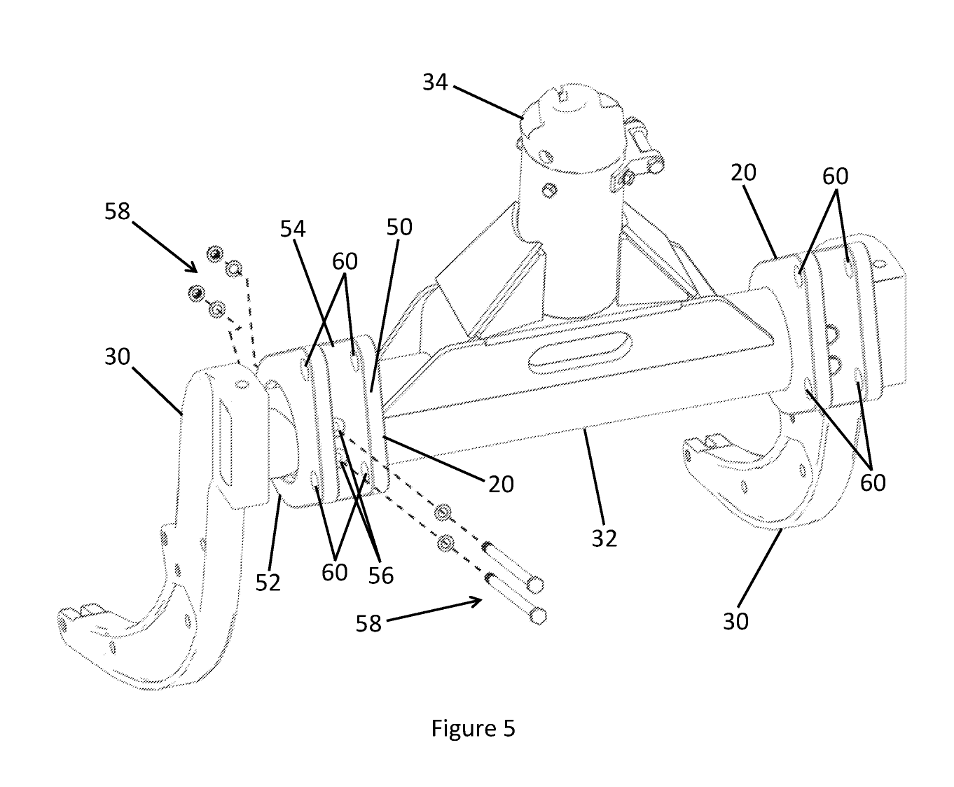

As shown in FIG. 5, hardware 58, such as bolts, extends through the openings 56 and openings 38 (not shown in FIG. 5) to secure the respective adapter 20 to the respective end of support bar 32.

The straight side 50 also includes a pair of openings 60 at both the top portion and the bottom portion of the straight side 50. The inwardly curved surface 54 of each adapter 20 is configured to receive a respective inboard arm 62 of the inboard store station 22. The openings 60 are configured to accept hardware 64, which hardware 64 extends through the openings 60 and through corresponding openings at an inboard arm 62 of the inboard store station 22 to secure the inboard store station 22 to the adapter 20, as shown in FIG. 6.

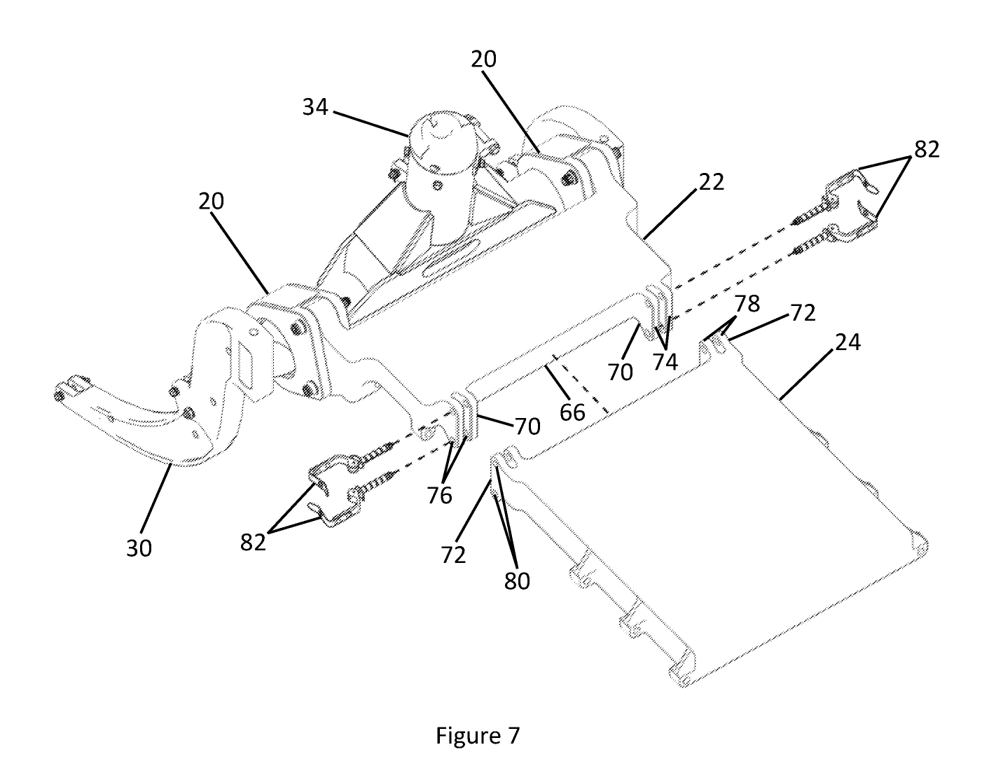

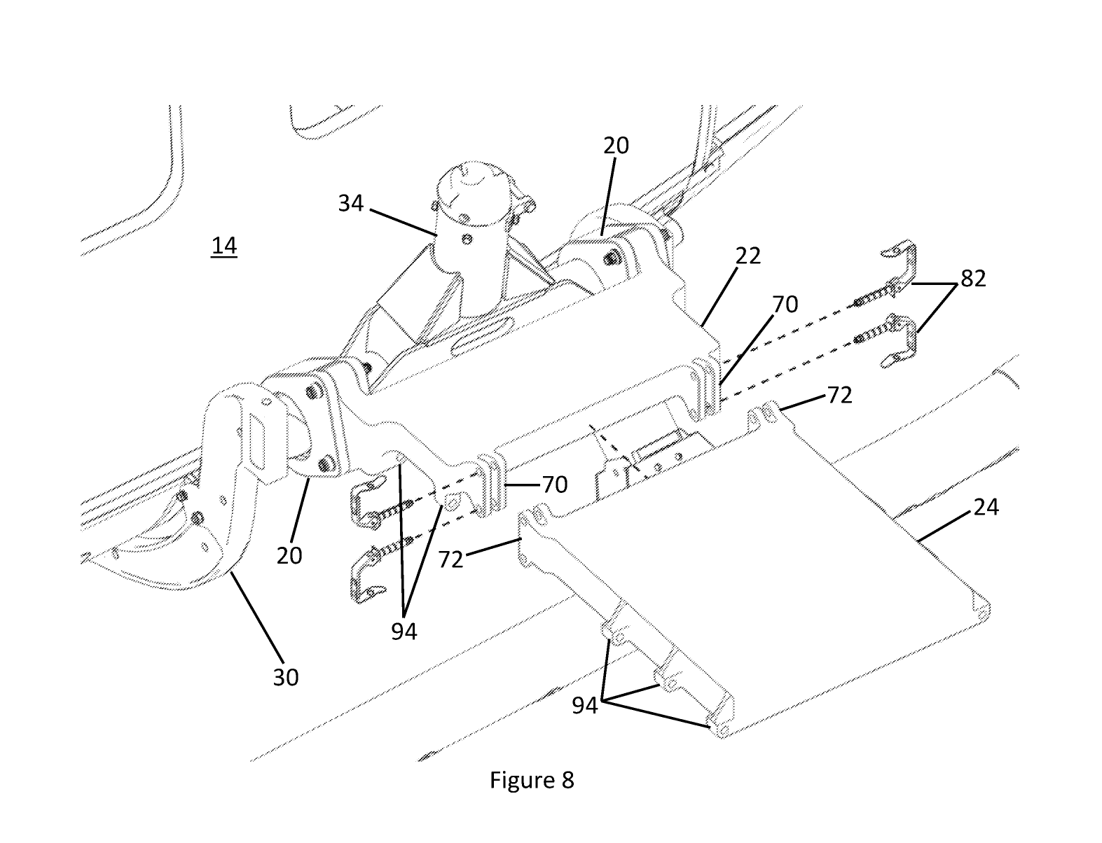

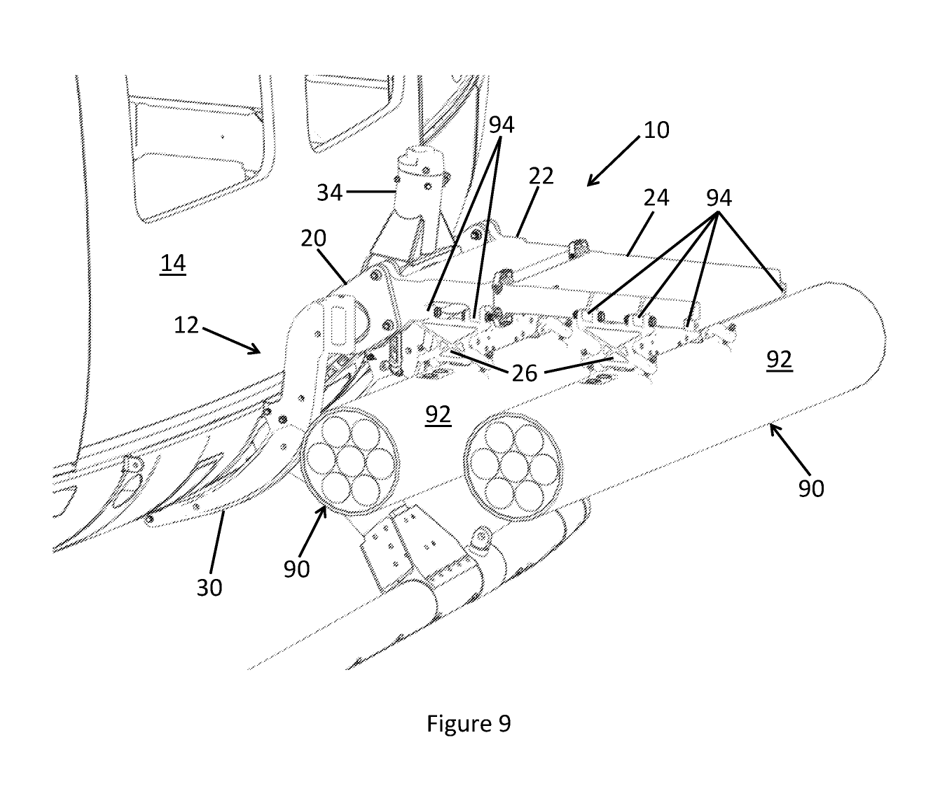

Referring to FIG. 7, there is shown a partial exploded view of the outboard store station 24 and the inboard store station 22. An outboard end 66 of the inboard store station 22 has a pair of spaced lugs 70 configured to selectively and securely receive respective inboard lugs 72 of the outboard store station 24. The lugs 70 each comprise a pair of parallel flanges 74 having respective aligned openings 76 extending through a top portion and a bottom portion of the flanges 74. Likewise, the lugs 72 each comprise a pair of parallel flanges 78 having respective aligned openings 80 extending through a top portion and a bottom portion of the flanges 78. The flanges 78 of the outboard store station 24 are configured to be selectively inserted between the flanges 74 of the inboard store station 22 in an interlaced arrangement, and fasteners 82, such as pins, extend through the openings 76 and 80 to selectively secure the outboard store station 24 to the inboard store station 22, as shown. These pins ensure a zero-clearance fit between the components, thus guaranteeing boresight retention and pinpoint accuracy of the attached weapon. The inboard store station 22 and the outboard store station 24 are coplanar, and form a complete station that extends generally horizontal from the side of the helicopter 14 cabin, as shown in FIG. 8 and FIG. 9.

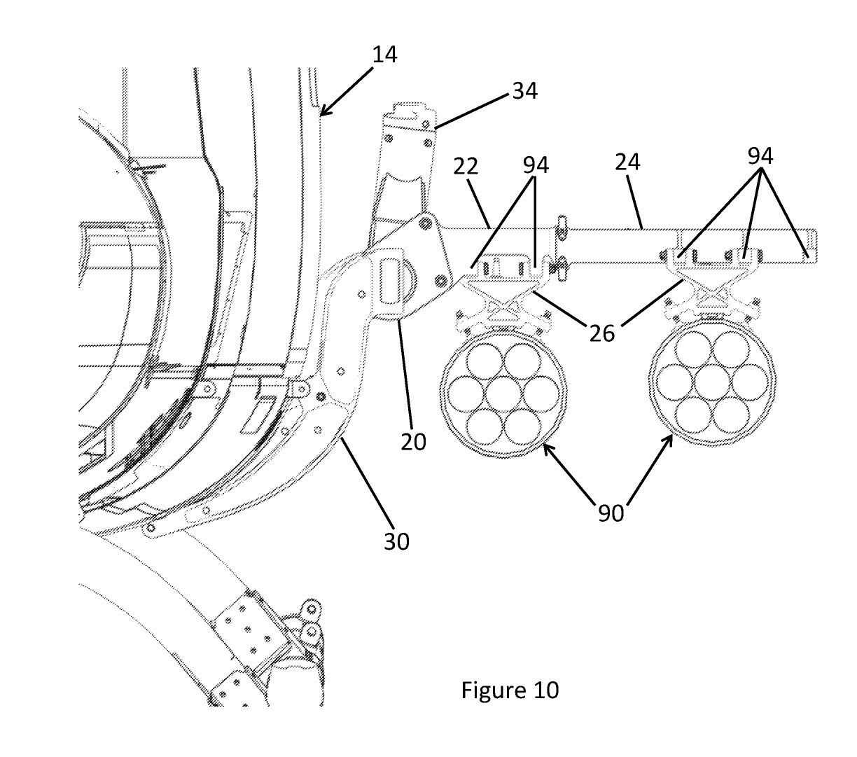

Referring to FIG. 9, there is shown a plurality of weapon stores 90 attached to the bomb rack adapters 26 of both the inboard store station 22 and the outboard store station 24. FIG. 9 illustrates a perspective view of the weapons mounting platform 10 outfitted with a pair of M260/LAU-68 7-shot rocket pods 92. FIG. 10 shows a front view of the inboard store station 22 and the outboard station 24 including the weapon stores 90. Also shown in FIG. 10 are three sets of evenly spaced lugs 94 integrated into the outboard store station 24 and two sets of evenly spaced lugs 94 integrated into the inboard store station 22 for gun mounts and bomb racks 26 for jettisonable payloads. As shown, the bomb rack adapters 26 are secured to the two inner lugs 94 on outboard store station 24 and on lugs 94 of inboard store station 22. For some weapon stores, the outer two lugs 94 may be used to meet military spec spacing requirements, and to achieve a balanced load and reduced moments.

### Legacy Compatibility

The weapons mounting platform 10 was designed with cost in mind. Legacy components, such as the support arms 30, pintle post 34 and BRU-59 bomb release units, are reused. The weapons mounting platform 10 is a simple, quick-install upgrade to the legacy IDAS 12. The lightweight Alkan bomb release unit and Alkan rack adapters are also configurable on the weapons mounting platform 10.

Though this disclosure has been described with respect to a specific embodiment(s), many variations and modifications will become apparent to those skilled in the art upon reading the present application. The intention is therefore that the appended claims be interpreted as broadly as possible in view of the prior art to include all variations and modifications.

We claim:

1. A weapons mounting platform configured to secure to an Improved Defense Armament System (IDAS) mounted to a helicopter, the IDAS having a pair of mounting arms, a support bar secured to and extending between the pair of mounting arms, and a pintle post, comprising:
an inboard store station configured to selectively and securably mount to the IDAS, the inboard store station having a first elongated member including a first store mount, and configured to extend horizontally from the helicopter when secured to the IDAS;
an adapter configured to selectively secure the inboard store station to the IDAS; and
an outboard store station configured to selectively and securably mount to the inboard store station, the outboard store station having a second elongated member including a second store mount, and configured to extend horizontally from the helicopter when secured to the inboard store station.

2. The platform as specified in claim 1 wherein the adapter is configured to secure to the support bar of the IDAS.

3. The platform as specified in claim 1 wherein the first elongated member is coplanar with the second elongated member.

4. The platform as specified in claim 1 further comprising a fastener configured to selectively secure an inboard end of the outboard store station to an outboard end of the inboard store station, wherein the inboard end of the outboard store station and the outboard end of the inboard store station each comprise openings configured to receive the fastener with zero tolerance.

5. The platform as specified in claim 1 wherein the support bar has a plurality of bar openings, wherein the adapter has a plurality of adapter openings configured to be aligned with the bar openings and receive a fastener to secure the adapter to the support bar.

6. The platform as specified in claim 5 wherein the adapter has an opening configured to receive an end of the support bar such that the adapter encompasses the support bar.

7. The platform as specified in claim 6 wherein the adapter is generally shaped like the letter D.

8. The platform as specified in claim 6 wherein the adapter extends at an upward angle between the support bar and an inboard end of the inboard store station to allow hardware to enter normal to a surface about the bar openings and keep the store stations separated from the ground.

9. The platform as specified in claim 2 wherein the adapter has a recess configured to receive an inboard end of the inboard store station.

10. The platform as specified in claim 3 wherein an outboard end of the inboard store station has a recess configured to receive an inboard end of the outboard store station.

11. The platform as specified in claim 1 wherein the outboard store station has a pair of said second store mounts defined by three sets of mounting lugs, and the first store mount is defined by a pair of mounting lugs.

12. A platform configured to secure to an armament mount secured to an outer surface of a UH-1 helicopter, the armament mount having a pair of mounting arms configured to secure to the outer surface of the UH-1 helicopter, a support bar secured to and extending between the pair of mounting arms, and a pintle post, comprising:
an inboard store station configured to selectively and securably mount to the armament mount, the inboard store station having a first elongated member including a first store mount, and configured to extend horizontally from the UH-1 helicopter when secured to the armament mount;
an adapter configured to selectively secure the inboard store station to the armament mount; and
an outboard store station configured to selectively and securably mount to the inboard store station, the outboard store station having a second elongated member including a second store mount, and configured to extend horizontally from the UH-1 helicopter when secured to the inboard store station.

13. The platform as specified in claim 12 wherein the adapter is configured to secure to the support bar.

14. The platform as specified in claim 12 wherein the first elongated member is coplanar with the second elongated member.

15. The platform as specified in claim 12 further comprising a fastener configured to selectively secure an inboard end of the outboard store station to an outboard end of the inboard store station, wherein the inboard end of the outboard store station and the outboard end of the inboard store station each comprise openings configured to receive the fastener with zero tolerance.

16. The platform as specified in claim 12 wherein the support bar has a plurality of bar openings, wherein the adapter has a plurality of adapter openings configured to be aligned with the bar openings and receive a fastener to secure the adapter to the support bar.

17. The platform as specified in claim 16 wherein the adapter has an opening configured to receive an end of the support bar such that the adapter encompasses the support bar.

18. The platform as specified in claim 17 wherein the adapter is generally shaped like the letter D.

19. The platform as specified in claim 17 wherein the adapter extends at an upward angle between the support bar and an inboard end of the inboard store station to allow hardware to enter normal to a surface about the bar openings and keep the store stations separated from the ground.

20. The platform as specified in claim 13 wherein the adapter has a recess configured to receive an inboard end of the inboard store station.

21. The platform as specified in claim 14 wherein an outboard end of the inboard store station has a recess configured to receive an inboard end of the outboard store station.

22. The platform as specified in claim 12 wherein the outboard store station has a pair of said second store mounts defined by three sets of mounting lugs, and the first store mount is defined by a pair of mounting lugs.
